(19) United States
(12) Patent Application Publication
(10) Pub. No.: US 2026/0042490 A1
(43) Pub. Date: Feb. 12, 2026

(54) DRIVE ASSEMBLY

(71) Applicant: BERK INTERNATIONAL PTY LTD, Victoria (AU)

(72) Inventor: James Darren BURKE, Victoria (AU)

(73) Assignee: BERK INTERNATIONAL PTY LTD, Victoria (AU)

(21) Appl. No.: 19/102,151

(22) PCT Filed: Aug. 23, 2023
(86) PCT No.: PCT/AU2023/050810

§ 371 Date: Feb. 7, 2025

(30) Foreign Application Priority Data
Aug. 24, 2022 (AU) 2022902427

(51) Int. Cl. B62D 33/04; F16H 19/04

(52) U.S. Cl. CPC B62D 33/04; F16H 19/04

(57) ABSTRACT

A drive assembly for moving a curtain of a vehicle includes a drive rack, an idle gear engaged with the drive rack, a motor assembly and an actuator. The motor assembly includes a drive gear engageable with the idle gear, a gearbox connected to the drive gear, and a motor connected to the gearbox for driving the drive gear. The actuator is for moving the motor assembly between an idle position, wherein the idle gear is idle, and a drive position, wherein the drive gear is engaged with the idle gear for driving the idle gear. When the motor assembly is in the drive position, the idle gear is drivable by the motor to move the idle gear along the drive rack. One of the drive rack and the idle gear is mountable on the curtain so as to move the curtain between a first and a second position.

### RELATED APPLICATIONS

This application claims convention priority from Australian Provisional Patent Application No. 2022902427, the contents of which are incorporated herein in their entirety by reference thereto.

### FIELD

This invention relates to a drive assembly for a movable curtain.

### BACKGROUND

Generally, in order that the contents loaded on a vehicle, such as a truck or train car, can be shaded so as to prevent the commodity from damage due to exposure to wind, sun and rain, a canopy frame may be provided on the loading surface of the vehicle and a top cover secures a top surface of the canopy frame. One or more side curtains may be provided on the vertical sides of the vehicle, usually on one or more of the longest sides of the vehicle. The sides curtains are typically movable to allow access to the loading surface when desired.

Thus, the curtain not only provides required shading to prevent the contents from exposure, but also provide security against opportunistic theft of the contents of the loading surface.

To provide the benefits of shelter and security, the curtains attached to these vehicles are typically quite substantial in weight and are thus quite difficult to move by hand. Prior attempts have been made to address this issue, such as in AU 2014101169. However, prior attempts have made the curtain unmovable by hand, due to the engagement forces required between the drive motor and the engagement surface on the canopy frame to provide effective drive forces for moving the curtain. This is a serious disadvantage, as access to the loading surface may be required when the vehicle is unpowered, such as in loading bays, unscheduled unloading events away from power sources, or power-failure of the drive assembly.

### SUMMARY

It is an object of the present invention to substantially address the above-mentioned disadvantage, or at least provide a useful alternative to the drive assembly discussed above.

A drive assembly for moving a curtain of a vehicle between a first and a second position, the drive assembly having:
a drive rack;
an idle gear that is engaged with the drive rack;
a motor assembly including:
   a drive gear that is engageable with the idle gear;
   a gearbox that is connected to the drive gear; and
   a motor connected to the gearbox for driving the drive gear, and
an actuator for moving the motor assembly between an idle position, wherein the idle gear is idle, and a drive position, wherein the drive gear is engaged with the idle gear for driving the idle gear,
wherein, when the motor assembly is in the drive position, the idle gear is drivable by the motor to move the idle gear along the drive rack, and wherein one of the drive rack and the idle gear is mountable on the curtain so as to move the curtain between the first and the second position.

The drive assembly of claim 1, wherein the drive rack is mounted to a body of the vehicle.

The drive assembly of claim 1, wherein the drive assembly includes a base plate, and the idle gear and actuator are mounted on the base plate, and wherein the base plate is mounted to the curtain of the vehicle.

The drive assembly of claim 3, wherein the drive assembly further includes a motor plate that is mounted on the base plate so as to be movable along a motor axis, and wherein the motor assembly is mounted on the motor plate such that movement of the motor plate along the motor axis allows movement of the motor assembly between the idle position and the drive position.

The drive assembly of claim 4, wherein the drive assembly further includes an actuator link that is pivotally connected at a first end to the actuator, and pivotally connected at a second end to the motor plate.

The drive assembly of claim 1, wherein the motor includes an electric motor and the actuator includes an electric actuator and the drive assembly further includes a battery pack to power the electric motor and the electric actuator.

The drive assembly of claim 6, wherein the electric motor has a rated torque of between 2-10 N m, more preferably between 3-5 N m, most preferably about 3.9 N m (40 kg cm).

The drive assembly of claim 6, wherein the battery pack has a capacity rating of between 2000-6000 mAh, more preferably between 3500-5000 mAh, most preferably about 4200 mAh.

The drive assembly of claim 6, wherein the electric actuator has a rated force of between 200-1000 N, more preferably between 350-650 N, most preferably about 500 N.

The drive assembly of claim 6, wherein the electric actuator has a stroke speed of between 10-50 mm s⁻¹, more preferably between 15-35 mm s⁻¹, most preferably about 20 mm s⁻¹.

The drive assembly of claim 1, wherein the drive assembly further includes a bias member to urge the idle gear towards the drive rack.

The drive assembly of claim 1, wherein the actuator includes a biased actuator movable between a first position and a second position corresponding to the idle position and the drive position of the motor assembly, respectively, and
wherein the actuator is biased towards the first position such that when the biased actuator is unpowered, the motor assembly is in the idle position.

Preferably, the drive assembly includes a charging assembly that is engageable with a power source of the vehicle.

Preferably, the charging assembly includes a charging pin located to engage a charging plate of the vehicle,
wherein the charging pin is biased toward the charging plate.

Preferably, the charging assembly includes a wireless power receiver coil adapted to engage a wireless power transmission coil of the vehicle.

### BRIEF DESCRIPTION OF THE DRAWINGS

Preferred embodiments of the present invention will now be described by way of example, with reference to the accompanying drawings, wherein:

FIG. 1 is an isometric detail view of the drive assembly of a prior art approach attached to a movable curtain of a vehicle.

FIG. 2 is a front elevation view of the drive assembly according to a preferred embodiment of the present invention.

FIG. 3 is a perspective view of the drive assembly of FIG. 2.

FIG. 4 is a detailed rear view of the drive assembly of FIG. 2.

FIG. 5 is a detailed side view of the drive assembly of FIG. 2.

FIG. 6 is a detailed perspective view of the drive assembly of FIG. 2.

### DETAILED DESCRIPTION

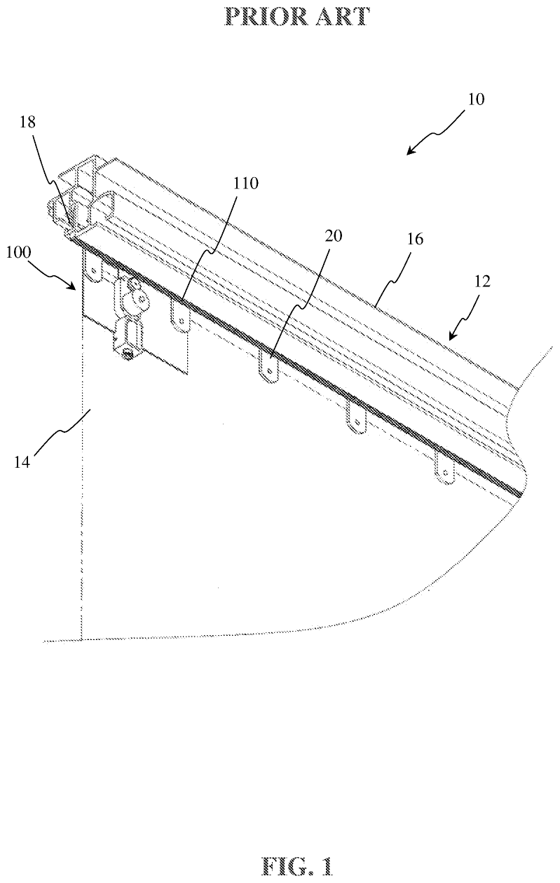

FIG. 1 shows a prior art drive assembly, however it is useful to consider as a drive assembly 100 according to a preferred embodiment of the present invention is mounted substantially similarly to a curtain 14 of a vehicle 10. The vehicle 10 has a body 12 that includes a loading surface (not shown) for receive contents to be transported by the vehicle, and a structure 16 extending above the loading surface for receiving one or more curtains 14. To this end, the structure 16 includes one or more channels 18. Runners 20 are attached to the curtain, each runner having one or more runner wheels 22 that are adapted to engage the channel 18 such that the curtain is movable suspended from the structure 16.

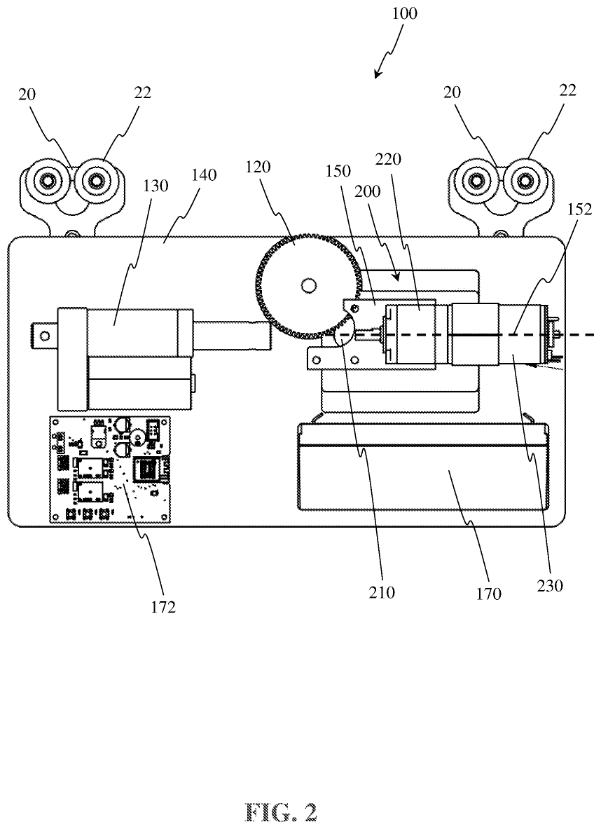

The drive assembly 100 includes a drive rack 110 mounted to the structure 16, preferably adjacent to the channel 18. Moving now to FIG. 2, the drive assembly 100 also includes an idle gear 120 that is engageable with the drive rack 110 such that torque applied to the idle gear 120 causes a force on the idle gear 120 induced by the idle gear's 120 engagement with the drive rack 110, the force being parallel to the drive rack 110.

The drive assembly 100 includes a base plate 140 that is preferably mounted between two runners 20 of the curtain 14, such that the curtain 14 between the runners 20 is substantially parallel to the channel 18. More preferably, the runners 20 are attached to the base plate 140. The idle gear 110 is located on the base plate 140. The drive assembly 100 further includes a motor plate 150 that is mounted on the base plate 140 so as to be movable along a motor axis 152. Preferably, the motor axis 152 is parallel to the drive rack 110. The drive assembly 100 further includes a motor assembly 200, which is preferably mounted on the motor plate 150. The motor assembly includes a drive gear 210 that is engageable with the idle gear 120, a gearbox 220 that is connected to the drive gear 210, and a motor 230 connected to the gearbox 220 for driving the drive gear 210.

The motor 230 is preferably an electric motor, more preferably a DC motor, preferably has a diameter of about 42 mm, preferably has an operating voltage of about 24 V, preferably has a no-load current of about 0.7 A, preferably has a rated current of about 7 A, preferably has a rated torque of about 40 kg cm, preferably has a no-load speed of about 165 rpm, and preferably has a rated speed of about 130 rpm. The gearbox preferably has a gear ratio of about 1:49.

The drive assembly 100 further includes an actuator 130 for moving the motor assembly 200 between an idle position and a drive position. In the idle position, the idle gear 120 is idle and able to move freely relative to the drive rack 110 while still engaged to the drive rack 110. In the drive position, the drive gear 210 is engaged with the idle gear 120 such that movement of the idle gear 120 along the drive rack 110 is driven by the drive gear 210.

Preferably, the actuator 130 is an electric actuator, more preferably a DC actuator, preferably has an operating voltage of about 24 V, preferably has a no-load current of about 0.8 A, preferably has a rated current of about 1.25 A, preferably has a stroke of about 20 mm, preferably has a stroke speed of about 20 mm s⁻¹, and preferably has a rated force of about 500 N.

While the arrangement of FIG. 1 is one possible arrangement, the position of the base plate 140 and the drive rack 110 could equally be reversed, such that the drive rack 110 is mounted on the curtain, for example as a flexible or folding drive rack 110, and the base plate 140 is mounted to the structure 16 of the vehicle 10. However, preferably, the drive rack 110 is mounted to the body 12 of the vehicle 10.

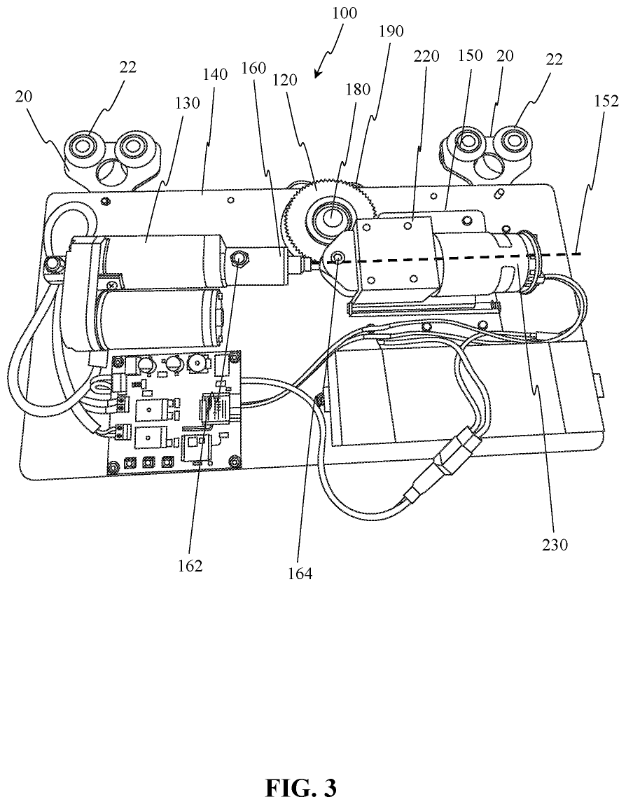

Moving briefly to FIG. 3, the drive assembly 100 further includes an actuator link 160 for connecting the actuator 130 to the motor plate 150. The actuator link 160 is pivotally connected at a first end 162 to the actuator 160 and pivotally connected at a second end 164 to the motor plate 150.

Returning to FIG. 2, the drive assembly 100 may include a battery pack 170 to power the electric motor 230 and the electric actuator 130. Preferably, the battery pack 170 has a nickel metal-hydride battery chemistry, preferably the battery pack 170 includes about 20 cells, preferably the rated voltage is about 24 V, and preferably the rated battery capacity is about 4200 mAh. The drive assembly 100 may also include a motor controller 172 to operate the electric motor 230 and the electric actuator 130 according to user inputs. The user input may be provided by physical user interface devices, such as buttons, levers, and the like. The motor controller 172 may also include a communication component, such as a radio communications module, such that the user input may also be provided by a personal computing device, such as a cellular telephone. In another embodiment, the motor controller 172 determines the required operations from context of the vehicle 10, such as the vehicle 10 arriving at a depot or at a pre-determined destination.

The drive assembly 100 may also include a bias member 180 to urge the idle gear 120 towards the drive rack 110. The actuator 130 may be a biased actuator 130 movable between a first position and a second position, corresponding to the idle position and the drive position of the motor assembly 200, respectively. The biased actuator 130 is biased towards the first position, such that when the biased actuator 130 is unpowered, for example because of a failure of the battery pack 170 or the vehicle 10 being unpowered when a battery pack 170 is not provided, the biased actuator 130 is urged towards the first position, and thus the motor assembly 200 is also urged towards the idle position.

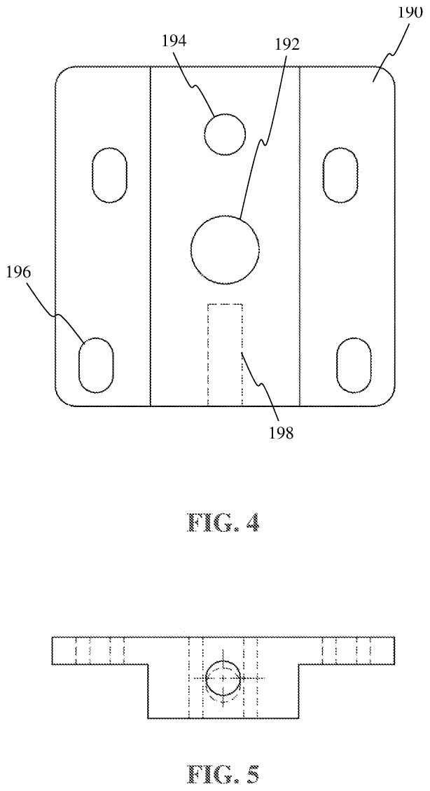

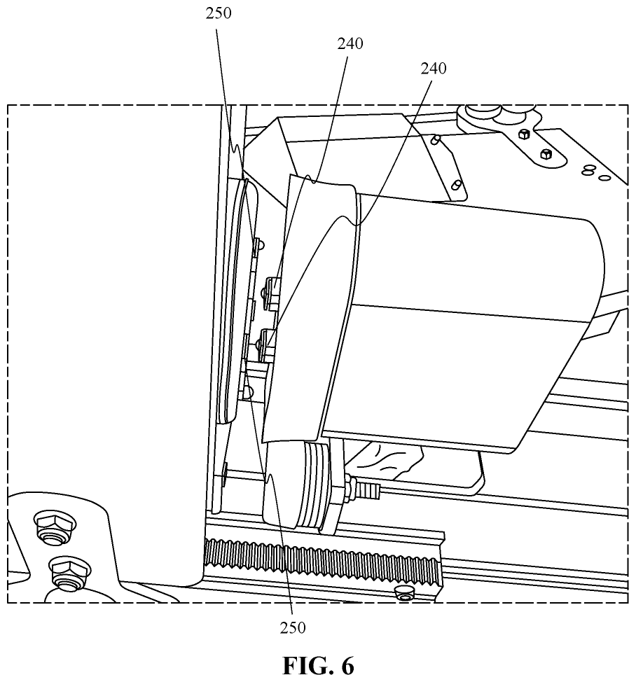

The drive assembly 100 further includes an adjustment plate 190 mounted on the base plate 140 and that is selectively movable in a direction perpendicular to the drive rack 110. Preferably, the direction in which the adjustment plate 190 is movable is also perpendicular to the motor axis 152. The adjustment plate 190 is shown in more detail in FIGS. 4 and 5. The idle gear 120 is mounted on the adjustment plate 190 at idle gear hole 192. If the bias member 180 is used, the bias member 180 is also mounted on the adjustment plate 190 at bias hole 194. The adjustment plate 190 is connected to the base plate 140 using the connector holes 196, which have an elongate shape in the adjustment direction to allow selective movement of the adjustment plate 190 relative to the base plate 140. Threaded opening 198 may receive a threaded fastener (not shown) that is connected to the base plate 140 to allow fine adjustment of the position of the adjustment plate 190 relative to the base plate 140.

The drive assembly 100 may also include a charging pin 240, preferably two charging pins 240, for contacting a contact plate 250, preferably two contact plates 250, mounted in an interior of the vehicle 10. When the drive assembly 100 has closed the curtain 14, the contact plates 250 are positioned to be engaged by the charging pins 240 to allow for power transfer to charge the battery pack 170. In a preferred embodiment, the charging pin 240 is biased towards the contact plate 250 to ensure good contact and reduce wear of the charging pin 240 and/or contact plate 250 due to arcing. In another embodiment, the drive assembly 100 includes a wireless power receiver coil (not shown), and the vehicle 10 includes a wireless power transmission coil (not shown) to, when the drive assembly 100 has closed the curtain 14, transfer power to the drive assembly 100 for charging the battery pack 170.

Use of the Drive Assembly 100 Will Now Be Discussed.

To set up the drive assembly 100, the adjustment plate 190 is selectively moved such that the idle gear 120 is in good engagement with the drive rack 110. Movement of the adjustment plate 190 is then inhibited, for example using a fastener.

In order to operate the drive assembly 100 to move the curtain 14, the actuator 130 is moved to the second position to move the motor assembly 200 to the drive position. The motor 230 is then operated in the desired direction to drive the drive gear 210, and thereby the idle gear 120, to impart a force on the base plate 140 in the desired direction causing movement of the base plate 140 and the curtain 14 to which it is attached in the desired direction from a first position before the movement to a second position after the movement.

If the environment is secure, the actuator 130 is moved to the first position to move the motor assembly 200 to the idle position, allowing manual movement of the curtain 14. As a security feature, the actuator 130 may remain in the second position to prevent manual movement of the curtain 14.

Advantages of the drive assembly 100 will now be discussed.

Because the motor assembly 200 is movable between the idle position and the drive position, the curtain 14 may be moved both by the drive assembly 100 and manually, as desired. The position of the drive rack 110 on the body 12 of the vehicle allows use of a mechanically simple drive rack 110. Use of the base plate 140 decreases the compliance of the curtain 14 at the location where translational force is applied to the curtain 14, decreasing the likelihood that the curtain 14 will jam during movement. Use of the motor plate 150 allows the motor assembly 200 to be moved collectively by a single actuator 130 between the idle position and the drive position. Use of the actuator link 160 removes the requirement for the actuator 130 to move precisely along the motor axis 152 and provides desirable manufacturing flexibility.

The use of an electric motor 230 and an electric actuator 130 allows the drive assembly 100 to be battery powered. This provides the option to prevent manual movement of the curtain 14 even when the vehicle 10 is unpowered. It also provides the option of moving the curtain 14 using the drive assembly 100 when the vehicle 10 is unpowered, avoiding unnecessary internal combustion engine emissions by the vehicle 10.

The use of the electric motor 230, the electric actuator 130, and the battery pack 170 as specified allows efficient operation and desirably small form factor of the drive assembly 100. The use of the bias member 180 increases the engagement force between the idle gear 120 and the drive rack 110, thereby decreasing the likelihood of slippage between the idle gear 120 and the drive rack 110. The use of the biased actuator 130 allows a fail-safe operation of the drive assembly 100 such that the curtain 14 is always operable, even if the vehicle 10 is unpowered.

### INTEGERS

10 vehicle
12 body
14 curtain
16 structure
18 channel
20 runner
22 runner wheel
100 drive assembly
110 drive rack
120 idle gear
130 actuator
140 base plate
150 motor plate
152 motor axis
160 actuator link
162 first end
164 second end
170 battery pack
172 motor controller
180 bias member
190 adjustment plate
192 idle gear hole
194 bias hole
196 connection hole
198 threaded opening
200 motor assembly
210 drive gear
220 gearbox
230 motor
240 charging pin
250 contact plate

What is claimed is:

1. A drive assembly for moving a curtain of a vehicle between a first and a second position, the drive assembly having:
a drive rack;
an idle gear that is engaged with the drive rack;
a motor assembly including:
a drive gear that is engageable with the idle gear;
a gearbox that is connected to the drive gear; and
a motor connected to the gearbox for driving the drive gear, and
an actuator for moving the motor assembly between an idle position, wherein the idle gear is idle, and a drive position, wherein the drive gear is engaged with the idle gear for driving the idle gear,
wherein, when the motor assembly is in the drive position, the idle gear is drivable by the motor to move the idle gear along the drive rack, and wherein one of the drive rack and the idle gear is mountable on the curtain so as to move the curtain between the first and the second position.

2. The drive assembly of claim 1, wherein the drive rack is mounted to a body of the vehicle.

3. The drive assembly of claim 1, wherein the drive assembly includes a base plate, and the idle gear and actuator are mounted on the base plate, and wherein the base plate is mounted to the curtain of the vehicle.

4. The drive assembly of claim 3, wherein the drive assembly further includes a motor plate that is mounted on the base plate so as to be movable along a motor axis, and wherein the motor assembly is mounted on the motor plate such that movement of the motor plate along the motor axis allows movement of the motor assembly between the idle position and the drive position.

5. The drive assembly of claim 4, wherein the drive assembly further includes an actuator link that is pivotally connected at a first end to the actuator, and pivotally connected at a second end to the motor plate.

6. The drive assembly of claim 1, wherein the drive assembly further includes an adjustment plate that is mounted on the base plate, the adjustment plate being selectively movable in a direction perpendicular to the drive rack,
wherein the idle gear is mounted on the adjustment plate.

7. The drive assembly of claim 1, wherein the motor includes an electric motor and the actuator includes an electric actuator and the drive assembly further includes a battery pack to power the electric motor and the electric actuator.

8. The drive assembly of claim 7, wherein the electric motor has a rated torque of between 2-10 N m, more preferably between 3-5 N m, most preferably about 3.9 Nm (40 kg cm).

9. The drive assembly of claim 7, wherein the battery pack has a capacity rating of between 2000-6000 mAh, more preferably between 3500-5000 mAh, most preferably about 4200 mAh.

10. The drive assembly of claim 7, wherein the electric actuator has a rated force of between 200-1000 N, more preferably between 350-650 N, most preferably about 500 N.

11. The drive assembly of claim 7, wherein the electric actuator has a stroke speed of between 10-50 mm s−1, more preferably between 15-35 mm s−1, most preferably about 20 mm s−1.

12. The drive assembly of claim 1, wherein the drive assembly further includes a bias member to urge the idle gear towards the drive rack.

13. The drive assembly of claim 1, wherein the actuator includes a biased actuator movable between a first position and a second position corresponding to the idle position and the drive position of the motor assembly, respectively, and
wherein the actuator is biased towards the first position such that when the biased actuator is unpowered, the motor assembly is in the idle position.

14. The drive assembly of claim 1, wherein the drive assembly includes a charging assembly that is engageable with a power source of the vehicle.

15. The drive assembly of claim 14, wherein the charging assembly includes a charging pin located to engage a charging plate of the vehicle,
wherein the charging pin is biased toward the charging plate.

16. The drive assembly of claim 14, wherein the charging assembly includes a wireless power receiver coil adapted to engage a wireless power transmission coil of the vehicle.
